(19) United States
(12) Patent Application Publication
(10) Pub. No.: US 2014/0307062 A1
(43) Pub. Date: Oct. 16, 2014

(54) SYSTEM AND METHOD FOR GENERATING A STEREOSCOPIC 3D PRESENTATION FROM PICTURE SEQUENCE EMANATING FROM SINGLE LENS SOURCE

(71) Applicant: ROTARY VIEW LTD., Petach Tikva (IL)

(72) Inventor: Gal Rotem, Petach Tikva (IL)

(73) Assignee: ROTARY VIEW LTD., Petach Tikva (IL)

(21) Appl. No.: 14/362,968

(22) PCT Filed: Dec. 5, 2012
(86) PCT No.: PCT/IL2012/050505

§ 371 Date: Jun. 5, 2014

Related U.S. Application Data
(60) Provisional application No. 61/566,701, filed on Dec. 5, 2011.

(51) Int. Cl. H04N 13/02

(52) U.S. Cl. CPC H04N 13/021; H04N 2013/0074
USPC 348/50

(57) ABSTRACT

A stereoscopic imaging system comprising a computerized interface operative to accept a sequence of 2d frames representing an object imaged, by an imaging user who is equipped with a single-lens camera, from a plurality of different viewing angles; an image sequence stereoscopic filtering subsystem operative to apply a right-eye stereoscopic filter to said sequence, thereby to yield a right-filtered sequence of frames and to apply a left-eye stereoscopic filter to said sequence, thereby to yield a left-filtered sequence of frames; and a frame combiner operative to combine frames from said right-filtered sequence with angularly separated frames from said left-filtered sequence respectively, thereby to yield a sequence of frames for viewing by a viewing user having a stereoscopic display device.

### REFERENCE TO CO-PENDING APPLICATIONS

Priority is claimed from U.S. Provisional Application 61/566,701, entitled “METHOD FOR GENERATING A STEREOSCOPIC 3D PRESENTATION FROM PICTURE SEQUENCE EMANATING FROM SINGLE LENS SOURCE” and filed 5 Dec. 2011.

### FIELD OF THIS DISCLOSURE

The present invention relates generally to imaging and more particularly to stereoscopy.

### BACKGROUND FOR THIS DISCLOSURE

Platforms which display objects from all possible angles, are known.

A stereoscopic 3-D view is a 2-D view with an illusion of depth. Generally this may be accomplished by presenting two offset images separately to the left and right eye of the viewer. Both of these 2-D offset images arc then combined in the brain to give an impression of 3-D depth.

In order to ensure that each eye views the desired image, one of three strategies are used: (1) have the viewer wear eyeglasses to combine separate images from two offset sources; (2) have the viewer wear eyeglasses to filter offset images from a single source separated to each eye; or (3) have the light source split the images directionally into the viewer's eyes (no glasses required; known as Autostereoscopy).

Relevant technologies known in the art include:

Complementary color anaglyphs, which employ one of a pair of complementary color filters for each eye. The most common color filters used are red and cyan. Employing tristimulus theory, the eye is sensitive to the three primary colors, red, green, and blue. The red filter admits only red, while the cyan filter blocks red, passing blue and green (the combination of blue and green is perceived as cyan). Another recently introduced form employs blue and yellow filters (yellow is the color perceived when both red and green light pass through the filter.)

Autostereoscopy is any method of displaying stereoscopic (3D) images without the use of special headgear or glasses on the part of the viewer. Because headgear is not required, it is also called “glasses-free 3D”. The technology includes two broad classes of displays: those that use head-tracking to ensure that each of the viewer's two eyes sees a different image on the screen, and those that display multiple views so that the display does not need to know where the viewers' eyes are directed. Examples of autostereoscopic displays include parallax barrier, lenticular, volumetric, electro-holographic, and light field displays.

Some autostereoscopic displays are also capable of recreating a perception of movement parallax, which is not possible with any of the active or passive technologies discussed above. “Movement parallax” refers to the fact that the view of a scene changes with movement of the head. Thus, different images of the scene are seen as the head is moved from left to right, and from up to down.

This is the method used by the Nintendo 3DS™ video game system and the Optimus 3D™ and LG Thrill™ by cellphone manufacturer LG Electronics MobileComm. USA.

Wiggle Stereoscopy, possibly the simplest stereogram viewing technique, involves simply alternating between the left and right images of a stereogram. In a web browser, this may be accomplished with an animated .gif image, Flash object, or JavaScript script. Most people can get a crude sense of dimensionality from such images, due to parallax.

Closing one eye and moving the head from side-to-side when viewing a selection of objects helps one understand how this works. Objects that are closer appear to move more than those further away. This effect may also be observed by a passenger in a vehicle or low-flying aircraft, where distant hills or tall buildings appear in three-dimensional relief, a view not seen by a static observer, as the distance is beyond the range of effective binocular vision.

Advantages of the wiggle viewing method include:

No glasses or special hardware required; it is the only method of stereoscopic visualization for people with limited or no vision in one eye;

Disadvantages of the “wiggle” method:

Does not provide true binocular stereoscopic depth perception; not suitable for print, limited to displays that can “wiggle” between the two images; difficult to appreciate details in images that are constantly “wiggling”; lack of 3D illusion to those who can detect the wiggling too easily.

Most wiggle images use only two images, leading to an annoyingly jerky image. A smoother image, more akin to a motion picture image where the camera is moved back and forth, may be composed by using several intermediate images (perhaps with synthetic motion blur) and longer image residency at the end images to allow inspection of details. Another option is a shorter time between the frames of a wiggle image.

Although the “wiggle” method is an excellent way of previewing stereoscopic images, it cannot actually be considered a true three-dimensional stereoscopic format. To experience binocular depth perception as made possible with true stereoscopic formats, each eyeball must be presented with a different image at the same time—this is not the case with “wiggling” stereo. The apparent effect comes from syncing the timing of the wiggle and the amount of parallax to the processing done by the visual cortex. Three or five images with good parallax may produce a better effect than simple left and right images.

Wiggling works for the same reason that a translational pan (or tracking shot) in a movie provides good depth information: the visual cortex is able to infer distance information from motion parallax, the relative speed of the perceived motion of different objects on the screen. Many small animals bob their heads to create motion parallax (wiggling) so they may better estimate distance prior to jumping.

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

Certain embodiments of the present invention seek to provide a method for generating a rotating 3D stereoscopic presentation and; more particularly, to a method for providing an online 3D stereoscopic presentation with a 360 degree rotation that is generated from a picture sequence of a 360 degree rotating object taken with a single camera. If the system of the present invention is implemented as a web-based system, it is appreciated that other than software, suitable computers, routers and telecommunications equipment are also provided.

Certain embodiments of the present invention serve an “imaging user”, typically a person who has an object such as but not limited to a vehicle or household object or garment or person or animal, which is to be viewed by a population of “viewing users”.

In accordance with an aspect of the presently disclosed subject matter, there is provided a stereoscopic imaging system comprising:
a computerized interface operative to accept a sequence of 2d frames representing an object imaged, by an imaging user who is equipped with a single-lens camera, from a plurality of different viewing angles;
an image sequence stereoscopic filtering subsystem operative to apply a right-eye stereoscopic filter to the sequence, thereby to yield a right-filtered sequence of frames and to apply a left-eye stereoscopic filter to the sequence, thereby to yield a left-filtered sequence of frames; and
a frame combiner operative, using a processor, to combine frames from the right-filtered sequence with angularly separated frames from the left-filtered sequence respectively, thereby to yield a sequence of frames for viewing by a viewing user having a stereoscopic display device.

In accordance with an embodiment of the presently disclosed subject matter, there is further provided a system wherein different sets of stereoscopic filters are provided which are constructed and operative to facilitate a stereoscopic view of the object using different stereoscopic display devices possessed by different viewing users.

In accordance with an embodiment of the presently disclosed subject matter, there is yet further provided a system wherein the filtering subsystem is operative to combine frames 1, 2, 3, . . . from the right-filtered sequence with angularly separated frames 2, 3, 4, . . . from the left-filtered sequence respectively.

In accordance with an embodiment of the presently disclosed subject matter, there is yet further provided a system wherein the filtering subsystem is operative to combine frames 1, 2, 3, . . . from the right-filtered sequence with angularly separated frames 3, 4, 5, . . . from the left-filtered sequence respectively.

In accordance with an embodiment of the presently disclosed subject matter, there is yet further provided a system comprising a viewer subsystem interfacing, on a client side, with a stereoscopic display device, and operative to allow the viewing user to control her or his stereoscopic viewing experience of the object.

In accordance with an embodiment of the presently disclosed subject matter, there is yet further provided a system comprising a server storing a multiplicity of sequences of 2d frames representing a corresponding multiplicity of objects imaged, by a corresponding multiplicity of imaging users equipped with single-lens cameras and wherein the filtering subsystem and frame combiner serve a population of viewing users stereoscopically viewing a selected one of the multiplicity of objects.

In accordance with an embodiment of the presently disclosed subject matter, there is yet further provided a system wherein the sequence of 2d frames represent an object imaged, by an imaging user who is equipped with a single-lens camera, from a plurality of different viewing angles spanning an entire 360 degree range of possible viewing angles.

In accordance with an embodiment of the presently disclosed subject matter, there is yet further provided a system wherein the viewing user can select an angular orientation at which to stereoscopically view the object, at a resolution limited by the number of frames in the sequence of 2d frames.

In accordance with an aspect of the presently disclosed subject matter, there is yet further provided a stereoscopic imaging method comprising:
providing a computerized interface operative to accept a sequence of 2d frames representing an object imaged, by an imaging user who is equipped with a single-lens camera, from a plurality of different viewing angles;
applying a right-eye stereoscopic filter to the sequence, thereby to yield a right-filtered sequence of frames and to apply a left-eye stereoscopic filter to the sequence, thereby to yield a left-filtered sequence of frames; and
combining frames from the right-filtered sequence with angularly separated frames, from the left-filtered sequence respectively, using a processor, thereby to yield a sequence of frames for viewing by a viewing user having a stereoscopic display device.

In accordance with an embodiment of the presently disclosed subject matter, there is yet further provided a method comprising using a single-lens camera, which may reside in a mobile device such as a smart phone, to generate the sequence of 2d frames representing an object imaged.

In accordance with an embodiment of the presently disclosed subject matter, there is yet further provided a method comprising circling an object with a single-lens camera while repeatedly imaging the object with the camera, in order to generate the sequence of 2d frames representing an object imaged.

In accordance with an embodiment of the presently disclosed subject matter, there is yet further provided a method comprising rotating an object while repeatedly imaging the object with a stationary single-lens camera, in order to generate the sequence of 2d frames representing an object imaged.

In accordance with an embodiment of the presently disclosed subject matter, there is yet further provided a system comprising a centering subsystem operative to detect the object in each frame within the sequence of 2d frames accepted by the computerized interface and to center each frame such that the object is equidistant from the top and bottom edges of the frame and is also equidistant from the right and left edges of the frame.

In accordance with an embodiment of the presently disclosed subject matter, there is yet further provided a system wherein the image sequence stereoscopic filtering subsystem is operative to duplicate the sequence, thereby to obtain first and second copies thereof which are stored in computer memory; and to apply a right-eye stereoscopic filter to the first copy of the sequence, thereby to yield the right-filtered sequence of frames and to apply a left-eye stereoscopic filter to the second copy of the sequence, thereby to yield the left-filtered sequence of frames.

In accordance with an aspect of the presently disclosed subject matter, there is yet further provided a computer program product, comprising a non-transitory tangible computer readable medium having computer readable program code embodied therein, the computer readable program code adapted to be executed to implement a stereoscopic imaging method comprising:
providing a computerized interface operative to accept a sequence of 2d frames representing an object imaged, by an imaging user who is equipped with a single-lens camera, from a plurality of different viewing angles;
applying a right-eye stereoscopic filter to the sequence, thereby to yield a right-filtered sequence of frames and to apply a left-eye stereoscopic filter to the sequence, thereby to yield a left-filtered sequence of frames; and
combining frames from the right-filtered sequence with angularly separated frames from the left-filtered sequence respectively, thereby to yield a sequence of frames for viewing by a viewing user having a stereoscopic display device.

Also provided, excluding signals, is a computer program comprising computer program code means for performing any of the methods shown and described herein when said program is run on a computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a typically non-transitory computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein, such as but not limited to steps of flowcharts, may be performed by a conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should he broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may he described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor may be employed to compute or generate information as described herein e.g. by providing one or more modules in the processor to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIG. 1 is a simplified pictorial illustration of a single lens source employed for 360 degree rotating object shooting, wherein resulting images may be uploaded to an application website e.g. via a PC or other local computing device including but not limited to a mobile device.

FIG. 2 is a diagram of an application wherein, on the server or client side, the application generates a stereoscopic new sequence e.g. by using a processor for unifying each picture in the sequence with adjacent or other pictures from the same sequence.

FIG. 3 is a simplified flowchart illustration of a method for providing stereoscopic images of an object from a range of angles, e.g. 360 degrees.

FIG. 4 is a simplified flowchart illustration of a method for performing step 125 of FIG. 3.

FIG. 5 is a simplified flowchart illustration of a method for performing step 130 of FIG. 3.

Computational components described and illustrated herein can be implemented in various forms, for example, as hardware circuits such as but not limited to custom VLSI circuits or gate arrays or programmable hardware devices such as but not limited to FPGAs, or as software program code stored on at, least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may he distributed over several code sequences such as but not limited to objects, procedures, functions, routines and programs and may originate from several computer files which typically operate synergistically.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

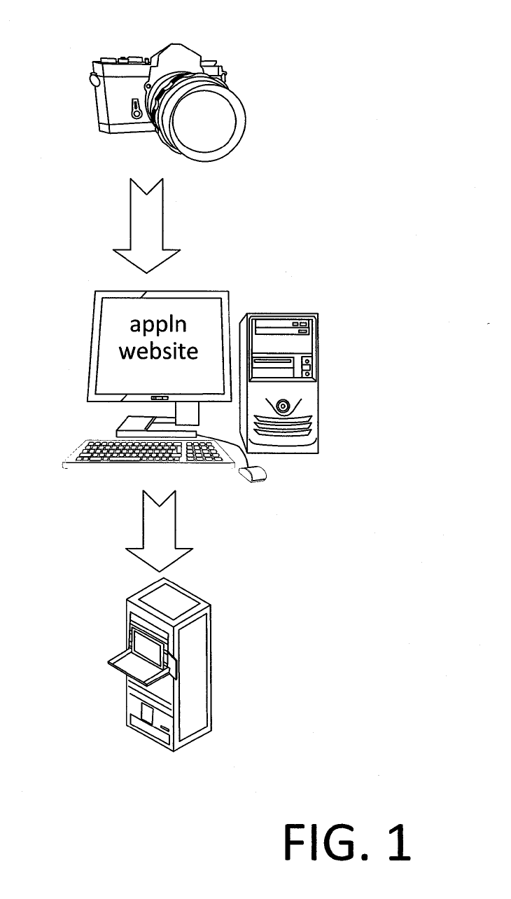

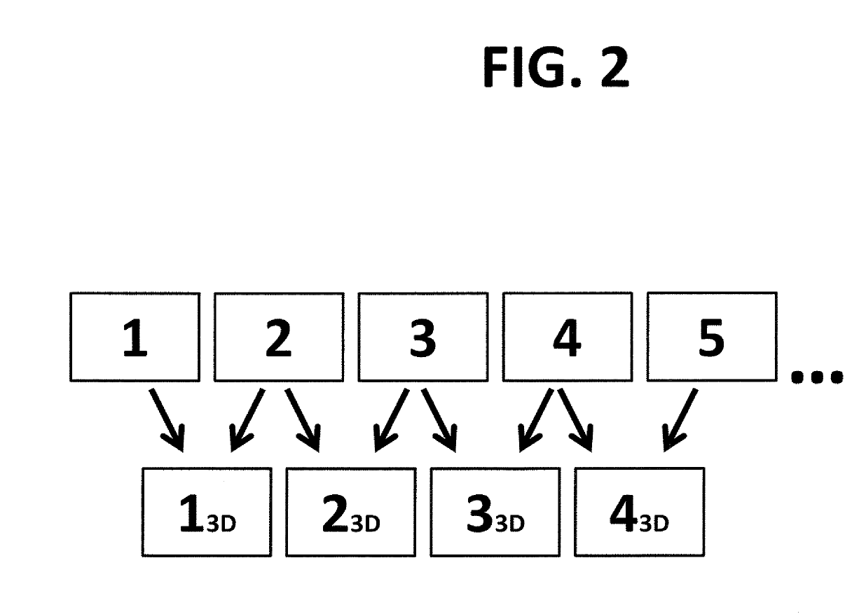

As shown in FIG. 1, typically, a single lens source is employed for 360 degree rotating object shooting (for example, a 36-picture sequence). The resulting images may he uploaded to an application website e.g. via a PC or other local computing device including but not limited to a pc or a mobile device. The images are then stored in application server/s, e.g. in any suitable form of computer memory. As shown in FIG. 2, typically on the server side, the application generates a stereoscopic new sequence e.g. by using a processor for unifying each picture in the sequence with adjacent or other pictures from the same sequence.

In some instances it is desirable to create a rotating 3D image for display. For example, in order to showcase an item for sale on a website, showing a revolving 3D presentation of the item is a great deal more effective than showing one or more 2D images taken from various angles. In order to create a 360 degree rotational view, a sequence of images capturing each aspect of the object is acquired. The images may be captured from a stationary position where the showcased object is placed on a rotating surface.

In order to capture a 360 degree image sequence, the object is mounted on a rotary table and pictured from a stationary camera, which may be mounted on a tripod or stand. The camera captures a sequence of images by rotating the table an increment before each image capture. Any sequence of pictures capturing the entire object is sufficient, although at least 24 images of the object, through a complete 360 degree rotation of the table, may be uploaded. For 24 images, each rotation increment may be a 15 degree rotation increment. For example, 36 images of the object, through a complete 360 degree rotation of the table, may be uploaded. Each rotation increment may be a 10 degree rotation increment. The more images captured, the smoother the rotating representation may be.

This method can be used successfully e.g. due to the large number of images in the sequence. Adding more images to the sequence typically increases quality.

According to certain embodiments, an online system provides a GUI (Graphic User Interface) on an Internet browser or through a client application downloaded from the system server, or the browser facilitates uploading the images to an application installed on the system server. The GUI allows a user to upload a sequence of images captured from an imaging source such as a camera. The sequence of images includes images of an object or scene from a 360 degree perspective of the object or scene. One exemplary method for capturing such a sequence is described above.

The system receives the uploaded images and generates a stereoscopic 3D sequence of images. Typically, the system unifies each image with the image next in sequence to create a 3D image. For example, images 1 and 2 are unified to become 3D image number one (1_{3D}), images 2 and 3 are unified to become image 2_{3D} images 3 and 4 become 3_{3D} etc. Alternatively, e.g. if the angle between images is too small then every second image can be paired, e.g. images 1 and 3 become 1_{3D}, images 2 and 4 become 2_{3D}, images 3 and 5 become 3_{3D} etc. A stereoscopic view of the 3D images is created by known methods for producing a stereoscopic view, some of which have been discussed above. As each 3D image is comprised of two images of the same object from slightly offset perspectives one from the other, known methods for creating the stereoscopic view can be applied to the compound images.

In certain embodiments of the invention, a rotary table is used to rotate an object incrementally. A rotary table is usually used for precision machine work with metal and therefore allows for rotating the base in a precise, controlled, manner. Or, a turntable or Lazy Susan can be used. In such cases, the desired degree of rotational incrementation may be marked, and a stationary marker provided as a reference point to be passed by each of the marks.

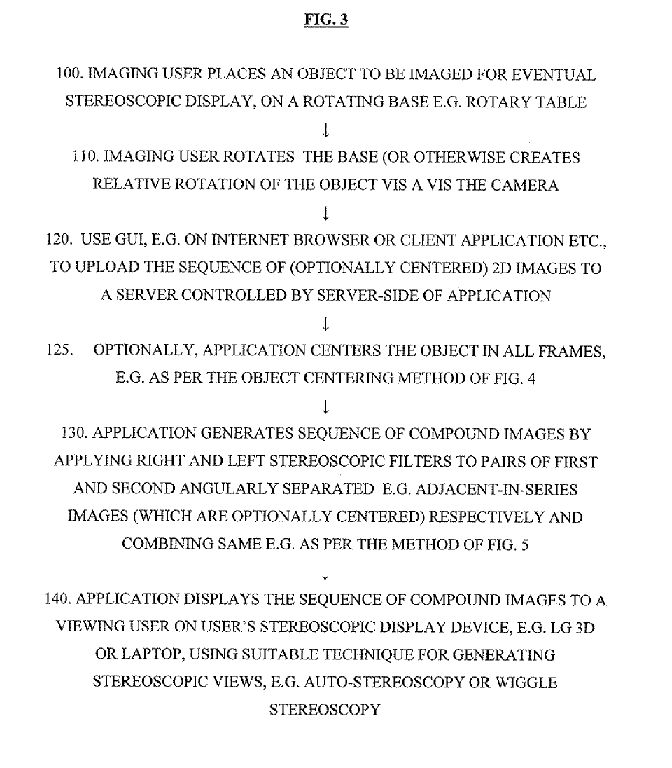

Reference is now made to FIG. 3 which is a simplified flowchart illustration of a method for providing stereoscopic images of an object from a range of angles, e.g. 360 degrees. The method of FIG. 3 typically comprises some or all of the following steps, suitably ordered e.g. as shown:

Step 100. Imaging user places an object to be imaged for eventual stereoscopic display, on a rotating base e.g. Rotary table.

Step 110. Imaging user rotates the base (or otherwise creates relative rotation of the object vis a vis the camera, e.g. by moving the camera around the object) and uses a (typically single-lens) camera to image a scene or the object, from various angular positions disposed along all of or at least a portion of a 360 degree azimuthal path e.g. a sequence of 36 or 45 or 60 or 80 or 100 or more 2d images of the object, typically approximately equally spaced e.g. 36 2d images approximately 10 degrees apart.

Step 120. Typically, use GUI, e.g. on Internet browser or client application etc., to upload the sequence of (optionally centered) 2d images to a server controlled by server-side of application.

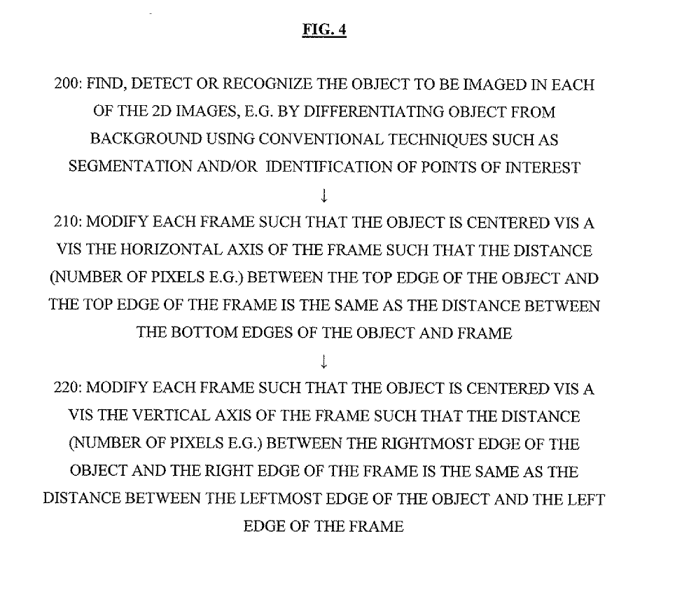

Step 125. Optionally, application centers the object in all frames, e.g. as per the object centering method of FIG. 4.

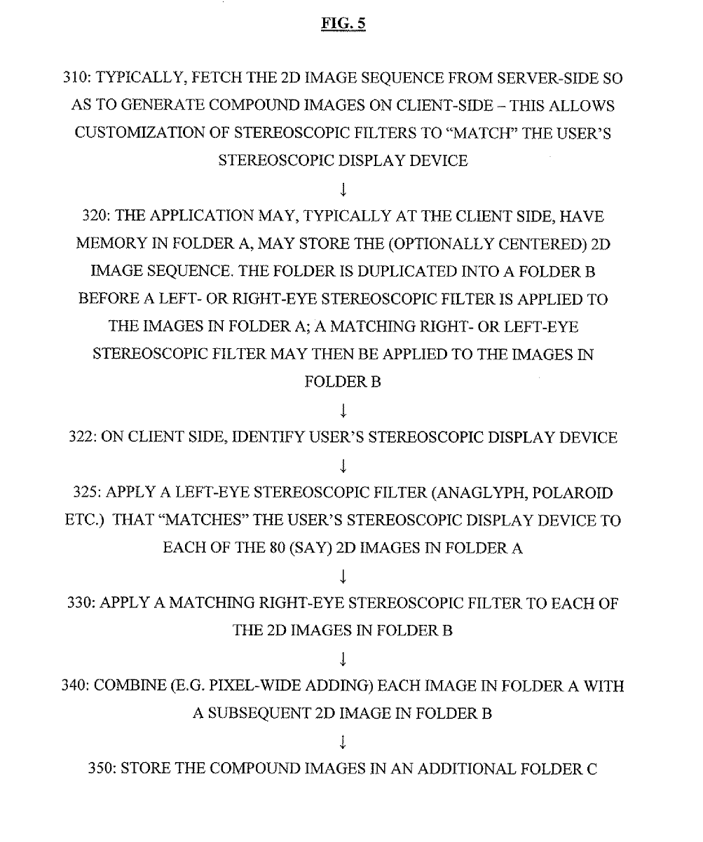

Step 130. Application generates sequence of compound images by applying right and left stereoscopic filters to pairs of first and second angularly separated e.g. adjacent-in-series images (which are optionally centered) respectively and combining same e.g. as per the method of FIG. 5.

The method may, typically, fetch the 2d image sequence from server-side & generate compound images on client-side, using stereoscopic filters that “match” the user's stereoscopic display device.

Compound images are typically generated by applying a left-eye stereoscopic filter (anaglyph, Polaroid etc.) To each of the 80 (say) 2d images and combining (e.g. pixel-wide adding) each of same with a subsequent 2d image to which a matching right-eye stereoscopic filter has been applied (e.g. 1^{st} compound image=pixel-wise combination of right-eye filtered image 1 & left-eye filtered image 2, 2^{nd} compound image=pixel-wise combination of right-eye filtered image 2 & left-eye filtered image 3, . . . 79^{th} compound image=pixel-wise combination of right-eye filtered image 79 & left-eye filtered image 80).

The application may, typically at the client side, have memory in which folders A and B are stored. Folder A may store the (optionally centered) 2d image sequence. The folder is duplicated into folder B before a right-eye stereoscopic filter is applied to the images in folder A. A matching left-eye stereoscopic filter may then he applied to the images in folder B. An additional folder stores the compound images which are displayed to the viewer.

Step 140. Application displays the sequence of compound images to a viewing user on user's stereoscopic display device, e.g. LG 3d or laptop, using suitable technique for generating stereoscopic views, e.g. auto-stereoscopy or wiggle stereoscopy. Display may comprise any of, or a selectable one of some or all of, an up to 360 degree panorama video sequence of the object, shown at any suitable speed, or a “still” image of the object from any user-selected viewing angle, the resolution of selection being determined, typically, by the number of images in the sequence. The speed at which a video panorama is displayed may be any suitable value such as 5, 10, 15, 20, 25 or 30 frames/sec, the speed optionally being selectable e.g. by the user.

Reference is now made to FIG. 4 which is a simplified flowchart illustration of a method for performing step 125 of FIG. 3. The method of FIG. 4 typically comprises some or all of the following steps, suitably ordered e.g. as shown:

Step 200: find, detect or recognize the object to he imaged in each of the 2d images, e.g. By differentiating object from background using conventional techniques such as segmentation and/or identification of points of interest.

Step 210: modify each frame such that the object is centered vis a vis the horizontal axis of the frame such that the distance (number of pixels e.g.) between the top edge of the object and the top edge of the frame is the same as the distance between the bottom edges of the object and frame;

Step 220: modify each frame such that the object is centered vis a vis the vertical axis of the frame such that the distance (number of pixels e.g.) between the rightmost edge of the object and the right edge of the frame is the same as the distance between the leftmost edge of the object and the left edge of the frame.

Reference is now made to FIG. 5 which is a simplified flowchart illustration of a method for performing step 130 of FIG. 3. The method of FIG. 5 typically comprises some or all of the following steps, suitably ordered e.g. as shown:

Step 310: typically, fetch the 2d image sequence from server-side so as to generate compound images on client-side—this allows customization of stereoscopic filters to “match” the user's stereoscopic display device.

Step 320: The application may, typically at the client side, have memory in Folder A may store the (optionally centered) 2d image sequence. The folder is duplicated into a folder B before a left- or right-eye stereoscopic filter is applied to the images in folder A; a matching right- or left-eye stereoscopic filter may then be applied to the images in folder B.

Step 322: on client side, identify user's stereoscopic display device

Step 325: apply a left-eye stereoscopic filter (anaglyph, Polaroid etc.) that “matches” the user's stereoscopic display device to each of the 80 (say) 2d images in folder A

Step 330: apply a matching right-eye stereoscopic filter to each of the 2d images in folder B

Step 340: combine (e.g. Pixel-wide adding) each image in folder A with a subsequent 2d image in folder B (e.g. 1^{st} compound image=pixel-wise combination of right-eye filtered image 1 from A & left-eye filtered image 2 from B. 2^{nd} compound image=pixel-wise combination of right-eye filtered image 2 from folder A & left-eye filtered image 3 from folder B, . . . 79^{th} compound image=pixel-wise combination of right-eye filtered image 79 from folder A & left-eye filtered image 80 from folder B). For example, the value of the first pixel in the first row of the right-eye filtered image 1 from A may be added to the value of the first pixel in the first row of the left-eye filtered image 2 from B to obtain a value for the first pixel in the first row of the first compound image. Similarly, the value of the second pixel in the first row of the right-eye filtered image 1 from A may be added to the value of the second pixel in the first row of the left-eye filtered image 2 from B to obtain a value for the second pixel in the first row of the first compound image, and so on. The value of the last pixel in the last row of the right-eye filtered image 1 from A may be added to the value of the last pixel in the last row of the left-eye filtered image 2 from B to obtain a value for the last pixel in the last row of the first compound image.

Step 350: store the compound images in an additional folder C.

One problem with taking two pictures with one camera is that the first camera position is not exactly parallel to the second camera position resulting in the pictures needing to be lined up so that the epipolar lines are parallel. This problem hardly exists with two cameras/lenses because they are fixed in parallel positions (or known relative positions). Using a stationary camera and a rotary table ensures that neither the camera nor the object change their position, only their aspect. This allows a user to use a single, widely available digital camera to capture the images and significantly reduces the computational time and resources needed to create such a 360 degree stereoscopic rotational presentation, allowing such a process to be better implemented online over a data network such as the Internet.

A particular advantage of stereoscopic display of an object from all possible angles, as per certain embodiments of the present invention, is that the object is clearly seen and appears 3d in that (a) the object appears to jut out from the plane of the display surface toward the viewer and/or away from the viewer; and/or (b) certain portions of the object appear closer to the viewer, than do other portions of the same object.

The method of the present invention typically does not require that the images in the sequence be exactly equally azimuthally spaced nor does it require a specific, exact number of images. For example, a user may hold a single-lens camera (which may reside on a mobile communication device such as a smart phone) and walk around the object, following a roughly circular trajectory as best s/he can, and image the object each time s/he takes a step. The number of images may only then be known ex post facto; the user need not take care to complete the circle using exactly some predetermined number of steps, instead any number of steps (e.g. at least 48) is acceptable.

A particular advantage of certain embodiments of the present invention is that the camera used to image the object need not be a stereoscopic or multi-lens camera.

A particular advantage of certain embodiments of the present invention is that the angular distance between a person's eyes is typically about 9 degrees, such that if at least 45 images of the object or scene are provided, the user's stereoscopic viewing experience is expected to be good since 360 degrees/45=8 degrees <9 degrees.

The camera may be integrally formed with a mobile (communication) device including but not limited to any of the following: mobile telephone, smart phone, playstation, iPad, TV, remote desktop computer, game console, tablet, mobile e.g. laptop or other computer terminal, embedded remote unit.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, he implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or, machine-readable media described herein is intended to include non-transitory computer- or machine-readable media.

Any computations or other forms of analysis described herein may be performed by a suitable computerized method. Any step described herein may he computer-implemented. The invention shown and described herein may include (a) using a computerized method to identify a solution to any of the problems or for any of the objectives described herein, the solution optionally includes at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system , computer-readable medium, apparatus, including only those functionalities performed at that server or client or node. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may he coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein,. functionalities described or illustrated as systems and sub-units thereof can also be provided as methods and steps therewithin, and functionalities described or illustrated as methods and steps therewithin can also he provided as systems and sub-units thereof. The scale used to illustrate various elements in the drawings is merely exemplary and/or appropriate for clarity of presentation and is not intended to be limiting.

1. A stereoscopic imaging system comprising:
a computerized interface operative to accept a sequence of 2d frames representing an object imaged, by an imaging user who is equipped with a single-lens camera, from a plurality of different viewing angles;
an image sequence stereoscopic filtering subsystem operative to apply a right-eye stereoscopic filter to said sequence, thereby to yield a right-filtered sequence of frames and to apply a left-eye stereoscopic filter to said sequence, thereby to yield a left-filtered sequence of frames; and
a frame combiner operative, using a processor, to combine frames from said right-filtered sequence with angularly separated frames from said left-filtered sequence respectively, thereby to yield a sequence of frames for viewing by a viewing user having a stereoscopic display device.

2. A system according to claim 1 and wherein different sets of stereoscopic filters are provided which are constructed and operative to facilitate a stereoscopic view of the object using different stereoscopic display devices possessed by different viewing users.

3. A system according to claim 1 wherein said filtering subsystem is operative to combine frames 1, 2, 3, . . . from said right-filtered sequence with angularly separated frames 2, 3, 4, . . . from said left-filtered sequence respectively.

4. A system according to claim 1 wherein said filtering subsystem is operative to combine frames 1, 2, 3, . . . from said right-filtered sequence with angularly separated frames 3, 4, 5, . . . from said left-filtered sequence respectively.

5. A system according to claim 1 and also comprising a viewer subsystem interfacing, on a client side, with a stereoscopic display device, and operative to allow the viewing user to control her or his stereoscopic viewing experience of the object.

6. A system according to claim 1 and also comprising a server storing a multiplicity of sequences of 2d frames representing a corresponding multiplicity of objects imaged, by a corresponding multiplicity of imaging users equipped with single-lens cameras and wherein the filtering subsystem and frame combiner serve a population of viewing users stereoscopically viewing a selected one of said multiplicity of objects.

7. A system according to claim 1 wherein said sequence of 2d frames represent an object imaged, by an imaging user who is equipped with a single-lens camera, from a plurality of different viewing angles spanning an entire 360 degree range of possible viewing angles.

8. A system according to claim 5 wherein said viewing user can select an angular orientation at which to stereoscopically view the object, at a resolution limited by the number of frames in said sequence of 2d frames.

9. A stereoscopic imaging method comprising:
providing a computerized interface operative to accept a sequence of 2d frames representing an object imaged, by an imaging user who is equipped with a single-lens camera, from a plurality of different viewing angles;
applying a right-eye stereoscopic filter to said sequence, thereby to yield a right-filtered sequence of frames and to apply a left-eye stereoscopic filter to said sequence, thereby to yield a left-filtered sequence of frames; and
combining frames from said right-filtered sequence with angularly separated frames from said left-filtered sequence respectively, using a processor, thereby to yield a sequence of frames for viewing by a viewing user having a stereoscopic display device.

10. A method according to claim 9 and also comprising using a single-lens camera, residing in a smart phone, to generate said sequence of 2d frames representing an object imaged.

11. A method according to claim 9 and also comprising circling an object with a single-lens camera while repeatedly imaging the object with the camera, in order to generate said sequence of 2d frames representing an object imaged.

12. A method according to claim 9 and also comprising rotating an object while repeatedly imaging the object with a stationary single-lens camera, in order to generate said sequence of 2d frames representing an object imaged.

13. A system according to claim 1 and also comprising a centering subsystem operative to detect the object in each frame within the sequence of 2d frames accepted by the computerized interface and to center each said frame such that the object is equidistant from the top and bottom edges of the frame and is also equidistant from the right and left edges of the frame.

14. A system according to claim 1 wherein said image sequence stereoscopic filtering subsystem is operative to duplicate said sequence, thereby to obtain first and second copies thereof which are stored in computer memory; and to apply a right-eye stereoscopic filter to said first copy of said sequence, thereby to yield said right-filtered sequence of frames and to apply a left-eye stereoscopic filter to said second copy of said sequence, thereby to yield said left-filtered sequence of frames.

15. A computer program product, comprising a non-transitory tangible computer readable medium having computer readable program code embodied therein, said computer readable program code adapted to be executed to implement a stereoscopic imaging method comprising:
providing a computerized interface operative to accept a sequence of 2d frames representing an object imaged, by an imaging user who is equipped with a single-lens camera, from a plurality of different viewing angles;
applying a right-eye stereoscopic filter to said sequence, thereby to yield a right-filtered-sequence of frames and to apply a left-eye stereoscopic filter to said sequence, thereby to yield a left-filtered sequence of frames; and
combining frames from said right-filtered sequence with angularly separated frames from said left-filtered sequence respectively, thereby to yield a sequence of frames for viewing by a viewing user having a stereoscopic display device.

16. A system according to claim 13 and wherein the centering subsystem detects the object in at least one frame by differentiating object from background using segmentation.

17. A system according to claim 13 and wherein the centering subsystem detects the object in at least one frame by identifying points of interest and using said points of interest to differentiate object from background.
